(19) United States
(12) Patent Application Publication
(10) Pub. No.: US 2015/0257552 A1
(43) Pub. Date: Sep. 17, 2015

(54) Apparatus, System, and Method for Organizing and Storing Earrings

(71) Applicant: Tina Dimitrion, Honolulu, HI (US)

(72) Inventor: Tina Dimitrion, Honolulu, HI (US)

(21) Appl. No.: 14/642,099

(22) Filed: Mar. 9, 2015

Related U.S. Application Data
(60) Provisional application No. 61/967,123, filed on Mar. 11, 2014.

(51) Int. Cl. A47F 7/02; F16B 2/22

(52) U.S. Cl. CPC A47F 7/02; F16B 2/22

(57) ABSTRACT

An apparatus, system, and method are disclosed for storing an earring. The apparatus includes a planar support member and at least one aperture. The support member has a first side, a second side and a peripheral edge. The first side is positioned opposite the second side with the peripheral edge separating the first side from the second side. The at least one aperture extends through the support member from the first side to the second side. The at least one aperture has an inner diameter smaller than an outer diameter of an earring post.

### CROSS-REFERENCES TO RELATED APPLICATIONS

This application claims the benefit of U.S. Provisional Patent Application No. 61/967,123 entitled “PIERCED EARRING ORGANIZING DEVICE” and filed on Mar. 11, 2014 for Tina Dimitrion, which is incorporated herein by reference.

### FIELD OF THE INVENTION

This invention relates to earring storage and more particularly relates to a jewelry device for a pierced earring holder invention which provides a simple, highly effective, durable, and economical way to store and organize pierced earrings without using any horizontal bureau, or hanging apparatus and which is not subject to breaking, cracking, or other mechanical malfunction.

### BACKGROUND

Earrings are typically small objects, sometimes of great monetary and/or sentimental value. Storage of earrings, so as not to misplace them, or to find them quickly when needed or to keep organized at home or when traveling is important to their owners. Jewelry boxes are most commonly used for this purpose. Often times it can be difficult to rummage through the case or box to find a particular pair of earrings. Within these jewelry boxes pairs of earring are easily separated and hard to locate. The storage of the earrings in this manner allows for the earring pairs to stay together and be easily found and thus organized. To date, little attention has been paid to devices for holding earring pairs together without having to purchase an additional display or free standing unit for the home or other cumbersome additions.

### SUMMARY

From the foregoing discussion, it should be apparent that a need exists for an apparatus, system, and method to store, organize and easily transport earrings without using any horizontal bureau, chest storage space, or hanging apparatus for storing organizing and transporting earrings. Beneficially, such an apparatus, system, and method would not be subject to breaking, cracking, or other mechanical malfunction.

The present invention has been developed in response to the present state of the art, and in particular, in response to the problems and needs in the art that have not yet been fully solved by currently available earring storage apparatus, systems and methods. Accordingly, the present invention has been developed to provide an apparatus, system, and method for storing earring that overcome many or all of the above-discussed shortcomings in the art.

The main object of the present subject matter is to provide a device that will be adapted to hold the earrings of a pair together, so that it will not be necessary to search for one earring, and then make a further search for the other earring of the same pair. The invention further being adapted to hold the earrings of each pair as to prevent them from becoming entangled with one another or misplaced.

Another object is to provide a device that will be so designed as to facilitate its engagement with or disengagement from the matched earrings. The post, wire or hoop of each earring will easily slip into each of the two small holes on the device of which the material of the device will be such that the post, wire or hoop of the earrings will be gripped and held without falling out.

Another object is to provide a holder for matched earrings that will be constructed, so as to be capable of manufacture at a reasonable and affordable cost as to justify fully their commercial feasibility.

The apparatus to store an earring, in one embodiment, includes a planar support member and at least one aperture. The support member has a first side, a second side and a peripheral edge. The first side is positioned opposite the second side with the peripheral edge separating the first side from the second side. The at least one aperture extends through the support member from the first side to the second side. The at least one aperture has an inner diameter smaller than an outer diameter of an earring post, wire or hoop.

In certain embodiments, a material lining the inner diameter of the aperture(s) has a coefficient of friction sufficient to maintain the earring post, wire or hoop within the aperture(s) when the support member is positioned with the aperture(s) extending in a substantially vertical orientation. In another embodiment, the support member is made of a first material having a structural rigidity sufficient to maintain the first side and the second side of the support member in a substantially planar orientation. In such an embodiment, the material lining the inner diameter of the at least one aperture may be made of a second material having a coefficient of friction sufficient to maintain the earring post, wire or hoop within the aperture(s) when the support member is positioned with the aperture(s) extending in a substantially vertical orientation.

In other embodiments, the entire may be made of a material having a coefficient of friction sufficient to maintain the earring post, wire or hoop within the aperture when the support member is positioned with the aperture extending in a substantially vertical orientation. For example, in one embodiment the planar support member is made of an elastomer having a coefficient of friction sufficient to maintain the earring post, wire or hoop within the aperture when the support member is positioned with the aperture extending in a substantially vertical orientation.

In an exemplary embodiment, the apparatus includes at least two apertures. Each of the apertures extend through the support member from the first side to the second side. The apertures have an inner diameter smaller than an outer diameter of the earring post, wire or hoop to maintain the earring post, wire or hoop within the apertures.

In yet another embodiment, the apparatus includes a plurality of apertures. In such an embodiment, each of the apertures extend through the support member from the first side to the second side and each of the apertures have an inner diameter smaller than the outer diameter of the earring post, wire or hoop to maintain the earring post, wire or hoop within the apertures.

In one embodiment, the inner diameters of the apertures is substantially smaller than about 0.033 inches. In another embodiment, in order to increase friction between the earring post, wire or hoop and the apertures, a depth of the peripheral edge (i.e., a depth of the support member) is greater than about 0.110 inch and less than about 0.433 inches. In an exemplary embodiment, a length of the support member is between about 0.400 inches and about 0.600 inches and a width of the support member is between about 0.300 inches and about 0.400 inches.

A method of the present invention is also presented for storing an earring. The method in the disclosed embodiments substantially includes the steps necessary to carry out the functions presented above with respect to the operation of the described apparatus. The method includes providing a planar support member having a first side, a second side and a peripheral edge. The first side is positioned opposite the second side with the peripheral edge separating the first side from the second side. The support member includes at least one aperture extending through the support member from the first side to the second side. The aperture(s) have an inner diameter smaller than an outer diameter of an earring post, wire or hoop to maintain the earring post, wire or hoop within the aperture(s).

In one embodiment, the method includes positioning the earring post, wire or hoop of an earring through the aperture. In embodiments wherein the support member includes a second aperture, the method also may include positioning a second earring post, wire or hoop of a second earring through the second aperture. In either embodiment, a material lining the inner diameter of the at least one aperture has a coefficient of friction sufficient to maintain the earring post, wire or hoop within the aperture when the support member is positioned with the aperture extending in a substantially vertical orientation.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a description of the subject matter will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1A is a top view illustrating one embodiment of an apparatus 100 to store an earring in accordance with the present subject matter;

FIG. 1B is a perspective view illustrating one embodiment of the apparatus to store an earring of FIG. 1 in accordance with the present subject matter;

FIG. 2 is a side view further illustrating the apparatus for storing an earring of FIG. 1 in accordance with the present subject matter;

FIG. 3A is an end view further illustrating the apparatus for storing an earring of FIG. 1 in accordance with the present subject matter;

FIG. 3B is an end view further illustrating the apparatus for storing an earring of FIG. 1 in accordance with the present subject matter;

FIG. 4A is a top view illustrating another embodiment of an apparatus to store an earring in accordance with the present subject matter;

FIG. 4B is a top view illustrating another embodiment of an apparatus to store an earring in accordance with the present subject matter;

FIG. 5 is a top view illustrating another embodiment of an apparatus to store an earring in accordance with the present subject matter; and

FIG. 6 is a schematic block diagram illustrating one embodiment of a method for storing an earring in accordance with the present subject matter.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided for a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Many women have difficulty keeping track of earring pairs. Often one of the earrings in an earring pair may be lost or otherwise misplaced. Earrings are generally placed on a shelf or in a jewelry box or the like in a disorganized fashion making it difficult to find a particular pair of earrings. Accordingly, there is a need for an organizing device on which earrings may be stored in pairs to make the items accessible to the user or to make the choice of which particular item to use, an easy one. The fact is that most jewelry containers or holders require the user to dig through the container for jewelry, and particularly earrings as they are smaller and generally worn as a pair, to find the one particular pair that is desired. In many cases, it is not so important to find one particular item as to be given the opportunity to choose among a number of items to find the one that is most appropriate for the attire being worn.

The present subject matter provides for a way to secure, keep, store, travel with earrings and for easy retrieval of matched earring pairs from a jewelry box, travel case, purse, or the like, where earring are placed in small compartments or in a large single compartment. Some individuals do not want to or cannot purchase additional “furniture” to store said jewelry.

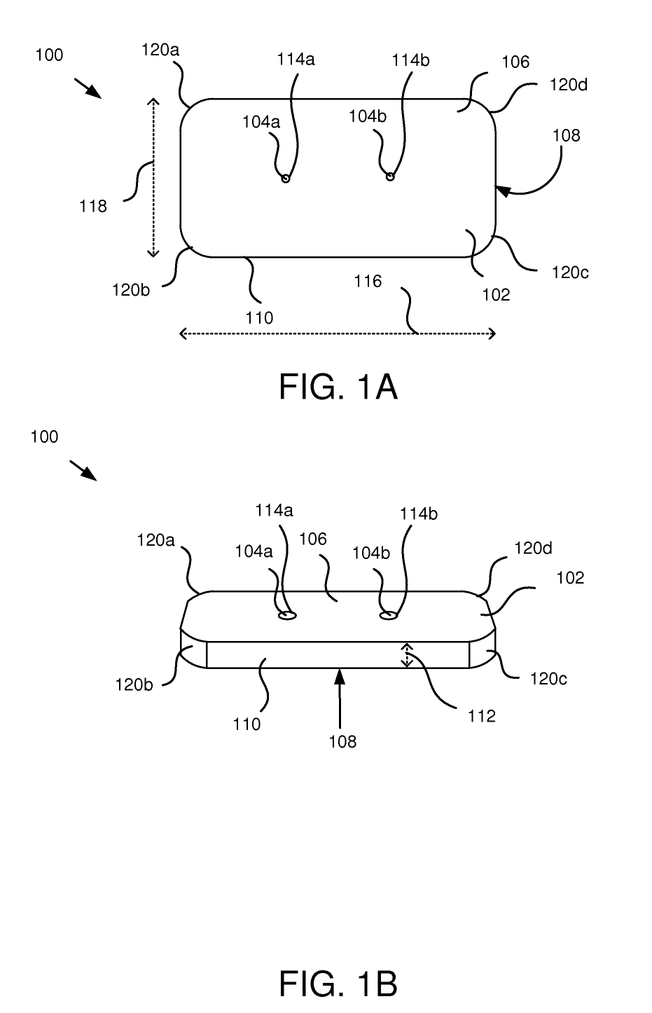

FIG. 1A is a top view illustrating one embodiment of an apparatus 100 to store an earring in accordance with the present subject matter. FIG. 1B is a perspective view illustrating one embodiment of the apparatus 100 to store an earring of FIG. 1A in accordance with the present subject matter.

In certain embodiments, the apparatus 100 includes a substantially planar member 102 and at least one aperture 104a and 104b (collectively apertures 104). The support member 102 includes a first side 106 positioned opposite a second side 108. A peripheral edge 110 extends about the periphery of the support member 102 and separates the first side 106 from the second side 108.

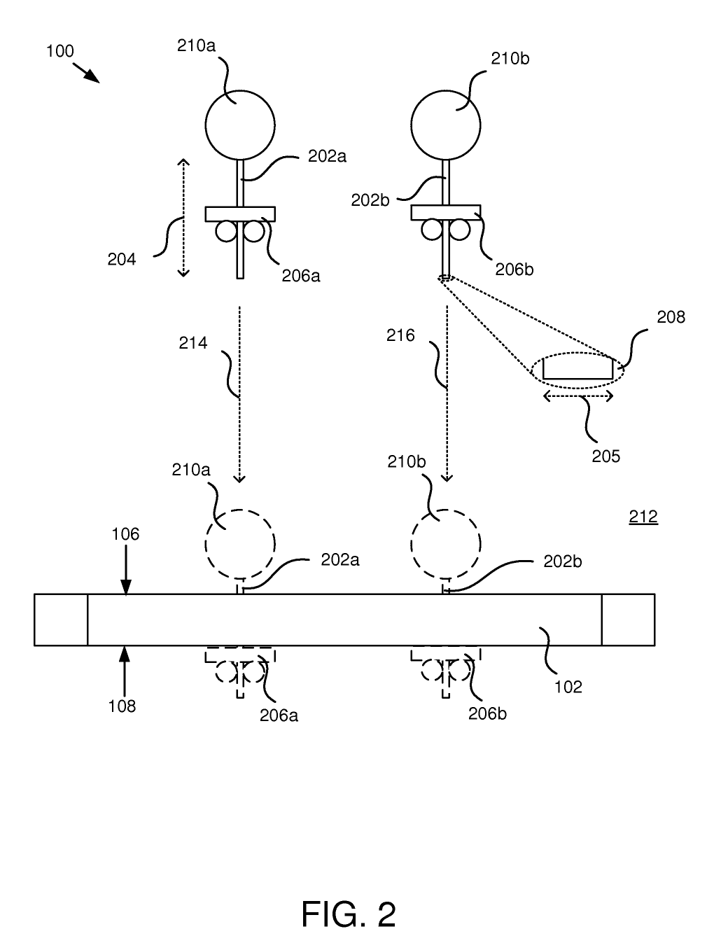

In one embodiment, the peripheral edge 110 of the planar member 102 has a depth, as illustrated by arrows 112, which is greater than about 0.110 inches and less than about 0.433 inches. The depth 112 of the peripheral edge 110, in an exemplary embodiment, is sufficient to facilitate maintaining an earring post 202a or 202b (see FIG. 2, collectively earring posts 202) positioned within an aperture 104a or 104b when the earring posts 202 are disposed within the apertures 104 as is further discussed below.

One of skill in the art will recognize that a conventional earring has an earring post 202a or 202b that has a length, as illustrated by arrow 204 (see FIG. 2) of about 0.433 inches. Thus, in certain embodiments, the peripheral edge 110 has a depth 112 less than 0.433 inches. In an exemplary embodiment, the depth 112 of the peripheral edge 110 is small enough to allow a user to position an earring back 206a or 206b (see FIG. 2, collectively earring backs 206) on the earring post 202a or 202b when the earring post 202a or 202b has been extended through the aperture 104a or 104b. Thus, in an exemplary embodiment, the depth 112 of the peripheral edge 110 is less than about 0.250 inches.

In a preferred embodiment, the depth 112 of the peripheral edge 110 is about 0.125 inches. It has been found that a planar member 102 having a peripheral edge 110 with a depth 112 of about 0.125 inches provides sufficient friction on the earring post 202a or 202b when the earring post 202a or 202b has been extended through the aperture 104a or 104b to keep the earring post 202a or 202b positioned within the aperture 104a or 104b without using the earring backs 206a or 206b to maintain the earring posts 202a or 202b within the aperture 104a or 104b. Additionally, a planar member 102 having a peripheral edge 110 with a depth 112 of about 0.125 inches allows a user to add the earring backs 206a or 206b to the earring posts 202a or 202b should the user so desire.

As discussed above, the support member 102 includes at least one aperture 104a and 104b through which the earring post 202a or 202b may be positioned to store the earring. While the embodiment illustrated in FIGS. 1A and 1B depict the support member 102 as including two apertures 104a and 104b, in other embodiments the support member 102 may include a single aperture 104a or 104b. In other embodiments, such as an embodiment where the apparatus 100 is designed to hold a greater number of earrings, the support member 102 may include more than two apertures 104a and 104b.

Each aperture 104 extends through the support member 102 from the first side 106 and through the second side 108. The apertures 104 have an inner diameter 114a and 114b respectively (collectively inner diameters 114) that is substantially smaller than an outer diameter, as illustrated by arrow 206, in the enlarged section 208 of earring post 202b of earring 210b (see FIG. 2). One of skill in the art will recognize that a conventional earring post 202a or 202b has an outer diameter of about 0.033 inches. Thus, in certain embodiments, the inner diameters 114 of the apertures 104 are smaller than about 0.033 inches.

In certain embodiments, the material making up the support member 102 comprises a material having a coefficient of friction that is sufficient to keep an earring post 202a or 202b positioned within an aperture 104a or 104b when the support member 102 is positioned with the aperture 104a or 104b extending in a substantially vertical orientation 212 as shown in FIG. 2. For example, in one embodiment, the support member 102 may be made of an elastomer having a coefficient of friction sufficient to maintain an earring post 202a or 202b within the aperture 104a or 104b when the support member 102 is positioned with the aperture 104a or 104b extending in a substantially vertical orientation 212. Materials suitable for construction of the support member 102 include rubber, synthetic rubber, silicon, and the like.

By using an elastomer to construct the support member 102, the inner diameters 114 of the apertures 104 may be sized slightly smaller than an outer diameter 205 of the earring posts 202. Because the support member 102 is made of an elastomer, the apertures 104 are flexible to accommodate the relatively larger outer diameters 205 of the earring posts 202. Once the earring posts 202 are positioned within the apertures 104, the slightly smaller inner diameters 114 facilitate maintaining the earring posts 202 within the apertures 104. Accordingly, in certain embodiments, the earring posts 202 may be maintained within the apertures 104 without the aid of the earring backs 206.

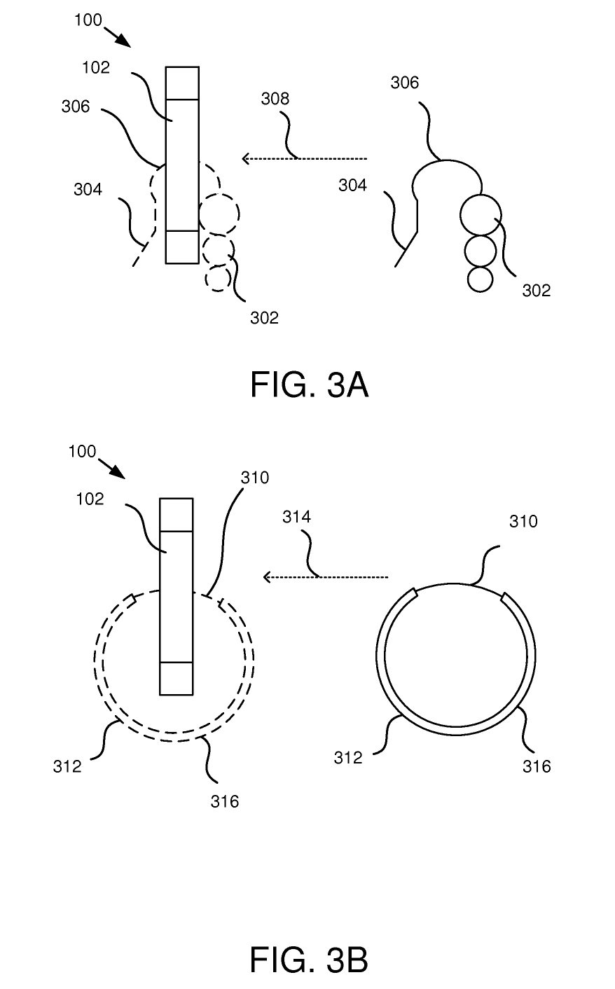

While the embodiments illustrated in FIG. 2 depicts the apparatus 100 as including apertures 104 sized to receive earring posts 202, one of the skill in the art will recognize that in certain embodiments, the diameter 205 of earring posts 202 is substantially similar to the diameter of a wire 304 (see FIG. 3A) as is used in a dangle style earring 302 (see FIG. 3A). Similarly, the diameter 205 of earring posts 202 is substantially similar to the diameter of a coupling element 310 (see FIG. 3B) in a hoop style earring 312 (see FIG. 3B). Thus, in certain embodiments, the apparatus 100 includes at least one aperture 104 having an inner diameter smaller than an outer diameter of an earring coupling member. As used herein, an earring coupling member refers to an element of the earring 210, 302, or 312 that is designed to be positioned through a user's earlobe to couple the earring 210, 302, or 312 to the user's earlobe.

For example, with post style earrings 210, as depicted in FIG. 2, the earring coupling member is the posts 202. With dangle style earrings 302, as depicted in FIG. 3A, the earring coupling member is the thin wire 304 which is positionable through a hole in the user's earlobe. Finally, with loop style earrings 312, as depicted in FIG. 3B, the earring coupling member is the coupling element 310 that is sized and shaped to extend through a hole in the user's earlobe. One of skill in the art will recognize that the earring coupling member of each of the above referenced earring styles have roughly the same diameter regardless of the style of earring. Further, one of skill in the art will recognize that other earring may have alternative earring coupling members and that in such embodiments, the alternative earring coupling members may have diameters substantially similar to the diameters of the earring posts 202, the thin wire 304 or the earring coupling element 310 of the above referenced earrings 210, 302, or 312 respectively.

In the embodiment illustrated in FIG. 1, the support member 102 is sized to hold two earrings. In certain embodiments, the support member 102 is also sized to be conveniently stored in a user's pocket, purse or other storage receptacle. Thus, in one embodiment, the length, as illustrated by arrows 116, of the support member 102 is between about 0.400 inches and about 0.600 inches and a width, as illustrated by arrows 118, of the support member 102 is between about 0.300 inches and about 0.400 inches. In a preferred embodiment, the length 116 of the support member 102 is about 0.500 inches and the width 118 of the support member 102 is about 0.3125 inches.

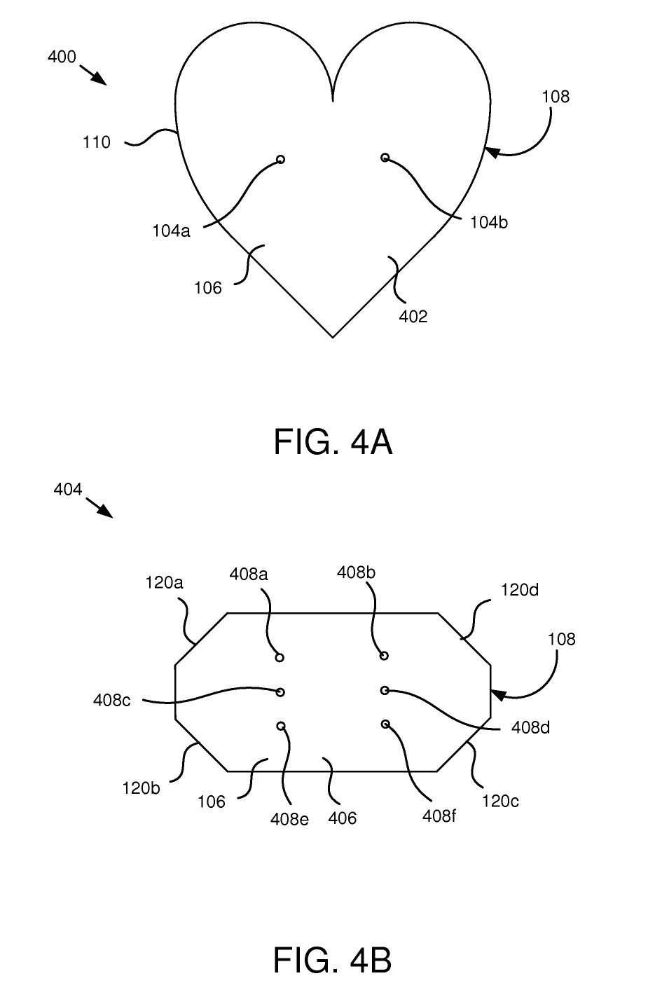

In order to avoid snagging a corner 120a-120d (collectively corners 120) of the support member 102 the corners 120 of the support members 102 may be rounded as illustrated in FIG. 1. In other embodiments, such as the embodiment illustrated in FIG. 4B, the angle of the corners 120 may be lessened by removing the ninety degree angle. In either embodiment, the likelihood of catching a corner 120 of the support member 102 when the user is removing the support member 102 or 402 (see FIG. 4) is lessened.

FIG. 2 is a side view further illustrating the apparatus 100 for storing an earring of FIG. 1 in accordance with the present subject matter. The embodiment illustrated in FIG. 2 includes a pair of earrings 210a and 210b (collectively earrings 210). In use, the earring posts 202 of the earrings 210 are directed into and through the apertures 104 in the support member 102 in the direction indicated by arrows 214 and 216. The earring posts 202 of the earrings 210 extend into the apertures 104 of the support member 102 from the first side 106 of the support member 102 and through the second side 108 of the support member 102. Given the slightly smaller inner diameter 114 of the apertures 104 with respect to the outer diameter 205 of the earring posts 202, the earring posts 202 are maintained within the apertures 104. As discussed above, the depth 112 of the peripheral edge 110 of the support member 102 may also add surface area to the area of contact between the earring posts 202 and the inner diameter 114 of the apertures 104 to facilitate maintaining the earring posts 202 within the apertures 104.

In certain embodiments, a user may wish to position the earring backs 206 on the earring posts 202 to further assure that the earring posts 202 remain within the inner diameter 114 of the apertures 104. However, as discussed above, in an exemplary embodiment, positioning the earring backs 206 on the earring posts 202 may be unnecessary given the size of the inner diameter 114 of the apertures 104 with respect to the outer diameter 205 of the earring posts 202 and given the depth 112 of the peripheral edge 110 of the support member 102.

While the embodiment illustrated in FIG. 2 depict the apparatus 100 as being useful for post style earrings 210, one of skill in the art will recognize that the apparatus 100 may be used with dangle or hoop style earrings. For example, FIG. 3A is an end view further illustrating the apparatus 100 for storing an earring of FIG. 1 in accordance with the present subject matter.

The embodiment illustrated in FIG. 3A includes a dangle style earring 302. Dangle style earrings 302 are designed to flow from the bottoms of the earlobes, and are available in various lengths from a centimeter or two, all the way to brushing the shoulders. They are generally attached to the ear by the use of thin wires 304 which include a looping portion 306 that rests in the user's earlobe.

Typically, the wire 304 has an outer diameter that is substantially similar in size to the outer diameter 205 of the earring posts 202 of a post style earring 210. Thus, by inserting the wire 304 into the apertures 104 in the support member 102 in the direction indicated by arrow 308, the wire 304 of the dangle style earring 302 is maintained within the apertures 104 in a manner substantially similar to the manner in which the earring posts 202 are maintained within the apertures 104 in the support member 102 as discussed above.

FIG. 3B is an end view further illustrating the apparatus 100 for storing an earring of FIG. 1 in accordance with the present subject matter. In the embodiment illustrated in FIG. 3B, the apparatus 100 is designed to store a hoop style earring 312. Hoop style earrings 312, like dangle style earrings 302, are designed to flow from the bottoms of the earlobes, and are available in various diameters from a centimeter or two, all the way to diameters that cause the hoop style earring 312 to brush the shoulders.

In certain embodiments, the hoop style earring 312 includes a partial circular hoop 316. A coupling element 310 is disposed between opposing ends of the partial circular hoop 316. The coupling element 310 and the partial circular hoop 316 form a complete circle when the earring 312 is assembled. To engage the hoop style earring 312 within a hole in the user's ear, one end of the coupling element 310 is disengaged from an end of the partial circular hoop 316. The coupling element 310 is then positioned through the hole in the user's ear and re-engaged with the partial circular hoop 316 to complete the circle. In this manner, the hoop style earring 312 is hung from a hole in the user's ear.

Typically, the coupling element 310 has an outer diameter that is substantially similar in size to the outer diameter 205 of the earring posts 202 of a post style earring 210. Thus, by inserting the coupling element 310 into the apertures 104 in the support member 102 in the direction indicated by arrow 314, the coupling element 310 of the hoop style earring 312 is maintained within the apertures 104 in a manner substantially similar to the manner in which the earring posts 202 are maintained within the apertures 104 in the support member 102 as discussed above.

While the embodiments illustrated in FIGS. 1A-3 depict a support member 102 having a substantially rectangular shape with rounded corners 120, one of skill in the art will recognize that the support member 102 may have any other shape. For example, FIG. 4A is a top view illustrating one embodiment of an apparatus 400 to store an earring in accordance with the present subject matter.

In certain embodiments, the apparatus 400 to store an earring of FIG. 4A is substantially similar to the apparatus 100 to store an earring discussed above in relation to FIGS. 1A-3B. Thus, in one embodiment, the apparatus 400 to store an earring includes a planar support member 402 and at least one aperture 104a and 104b (collectively apertures 104). The apertures 104 are substantially similar to the apertures 104 discussed above in relation to FIGS. 1A-3B and will not be further discussed here.

The support member 402 includes elements substantially similar to the like elements of the support member 102 discussed above in relation to FIGS. 1A-3B. Thus, the support member 402 includes a first side 106, a second side 108, and a peripheral edge 110. The first side 106 is disposed opposite the second side 108 and the peripheral edge 110 extends around the support member 402 separating the first side 106 from the second side 108.

Unlike the generally rectangular shape of the support member 102 of FIGS. 1A-3, the support member 402 of FIG. 4A is formed in the shape of a heart. One of skill in the art will recognize that the heart shape of the support member 402 is for illustrative purposes only and that in other embodiments, the support member 402 may have other shapes.

FIG. 4B is a top view illustrating another embodiment of an apparatus 404 to store an earring in accordance with the present subject matter. In the embodiment illustrated in FIG. 4, the support member 406 includes a first side 106, a second side 108, and a peripheral edge 110. The first side 106 is disposed opposite the second side 108 and the peripheral edge 110 extends around the support member 406 separating the first side 106 from the second side 108.

The corners 120a-120c of the support member 406 are angled providing an overall emerald shape for the support member 406. Again, one of skill in the art will recognize that the emerald shape of the support member 406 is for illustrative purposes only and that in other embodiments, the support member 406 may have other shapes.

In the embodiment illustrated in FIG. 4B, the support member 406 includes a plurality of apertures 408a-408f (collectively apertures 408). The apertures 408 are substantially similar to the apertures 104 discussed above in relation to FIGS. 1A-3. Accordingly, the apparatus 404 of FIG. 4B is designed to hold three pairs of earrings 210, 302 or 312. In other embodiments, the apparatus 404 may include a greater or lesser number of apertures 408 to hold a greater or lesser number of pairs of earrings 210, 302 or 312.

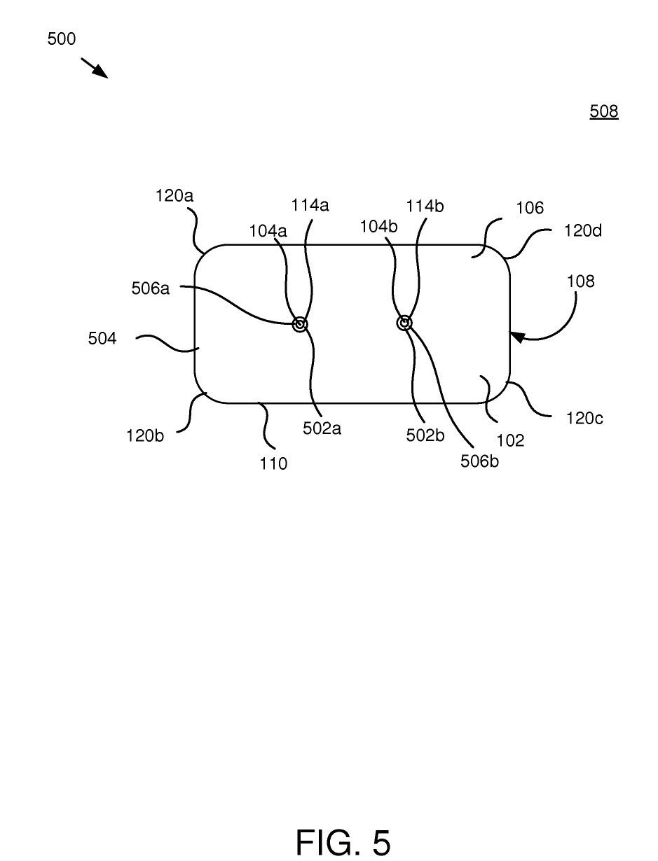

FIG. 5 is a top view illustrating another embodiment of an apparatus 500 to store an earring in accordance with the present subject matter. In certain embodiments, the apparatus 500 includes a planar support member 102 and at least one aperture 104a and 104b (collectively apertures 104) that extend through the support member 102.

In one embodiment, each aperture 104a and 104b is lined with a material 502a and 502b (collectively material 502) that has a coefficient of friction sufficient to maintain an earring post 202a and 202b within the aperture 104a or 104b when the support member 102 is positioned with the aperture 104a or 104b extending in a substantially vertical orientation and with the earrings 210 positioned substantially below the support member 102 with the earring post 202a or 202b extending up and through the aperture 104a or 104b.

In such an embodiment, the support member 102 may be made of a first material 504 and the material lining the inner diameter 114a and 114b (collectively inner diameters 114) of the apertures 104 may be made of a second material 506a and 506b (collectively a second material 506). In an exemplary embodiment, the first material 504 has a structural rigidity sufficient to maintain the first side 106 and the second side 108 in a substantially planar orientation 508. As discussed above, the second material 506 lining the inner diameters 114 of the aperture 104 has a coefficient of friction sufficient to maintain an earring post 202a and 202b within the aperture 104a or 104b when the support member 102 is positioned with the aperture 104a or 104b extending in a substantially vertical orientation and with the earrings 210 positioned substantially below the support member 102 with the earring post 202a or 202b extending up and through the aperture 104a or 104b. Of course, one of skill in the art will recognize that the apparatus 500 may be used to store a greater or lesser number of earrings as discussed above.

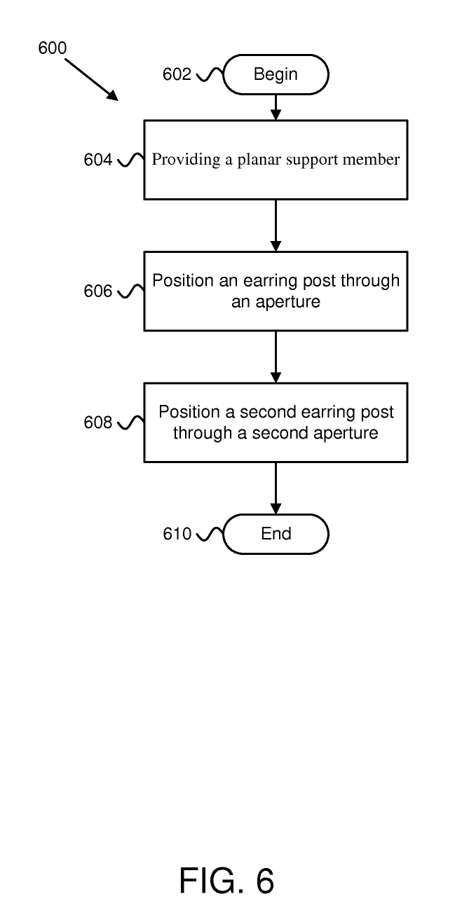

FIG. 6 is a schematic block diagram illustrating one embodiment of a method 600 for storing an earring 210, 302 and/or 312 in accordance with the present subject matter. In the following discussion, the method 600 will be described with reference to apparatus 100 discussed above. However, one of skill in the art will recognize that the method 600 may be used with any of the apparatus 100, 400, 404, or 500 discussed above.

The method 600 begins 602 and a planar support member 102 is provided 604. The planar support member 102 includes a first side 106, a second side 108 and a peripheral edge 110. The first side 106 is positioned opposite the second side 108 with the peripheral edge 110 separating the first side 106 from the second side 108. The support member also includes at least one aperture 104a and/or 104b (collectively apertures 104) that extends through the support member 102 from the first side 106 to the second side 108. The aperture(s) 104 have an inner diameter 114a and/or 114b that are substantially smaller than an outer diameter 205 of an earring coupling member (i.e., earring posts 202, the wire 304, or coupling element 310 of earrings 210, 302, or 312 respectively).

The method 600 proceeds and an earring coupling member is positioned 606 through one of the apertures 104. In certain embodiments, upon positioning 606 the earring coupling member through one of the apertures 104, the method ends 610.

In other embodiments, such as embodiments wherein the apparatus 100, 400, 404, or 500 includes more than one aperture 104 (i.e., a first aperture 104a and a second aperture 104b), the first coupling member positioned 606 through the first aperture 104a. In such an embodiment, the method 600 may include positioning 608 a second earring coupling member through the second aperture 104b. Upon positioning 608 the second earring coupling member through the second aperture 104b, the method 600 ends 610.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to store an earring, the apparatus comprising:
a planar support member comprising a first side, a second side and a peripheral edge, the first side disposed opposite the second side with the peripheral edge separating the first side from the second side; and
at least one aperture extending through the support member from the first side to the second side, the at least one aperture having an inner diameter smaller than an outer diameter of an earring coupling member.

2. The apparatus of claim 1, wherein a material lining the inner diameter of the at least one aperture has a coefficient of friction sufficient to maintain the earring coupling member within the aperture when the support member is positioned with the at least one aperture extending in a substantially vertical orientation.

3. The apparatus of claim 2, wherein the support member comprises a first material having a structural rigidity sufficient to maintain the first side and the second side of the support member in a substantially planar orientation and wherein the material lining the inner diameter of the at least one aperture comprises a second material.

4. The apparatus of claim 1, wherein the planar support member comprises a material having a coefficient of friction sufficient to maintain the earring coupling member within the aperture when the support member is positioned with the aperture extending in a substantially vertical orientation.

5. The apparatus of claim 1, wherein the planar support member comprises an elastomer having a coefficient of friction sufficient to maintain the earring coupling member within the aperture when the support member is positioned with the aperture extending in a substantially vertical orientation.

6. The apparatus of claim 1, wherein the at least one aperture comprises at least two apertures, each of the at least two apertures extending through the support member from the first side to the second side, each of the at least two apertures having an inner diameter smaller than the outer diameter of the earring coupling member.

7. The apparatus of claim 1, wherein the at least one aperture comprises a plurality of apertures, each of the plurality of apertures extending through the support member from the first side to the second side, each of the plurality of apertures having an inner diameter smaller than the outer diameter of the earring coupling member.

8. The apparatus of claim 1, wherein the inner diameter of the at least one aperture is substantially smaller than about 0.033 inches.

9. The apparatus of claim 1, wherein a depth of the peripheral edge is greater than about 0.110 inch and less than about 0.433 inches.

10. The apparatus of claim 1, wherein a length of the support member is between about 0.400 inches and about 0.600 inches, wherein a width of the support member is between about 0.300 inches and about 0.400 inches.

11. An apparatus to store an earring, the apparatus comprising:
a planar support member comprising a first side, a second side and a peripheral edge, the first side disposed opposite the second side with the peripheral edge separating the first side from the second side; and
at least one aperture extending through the support member from the first side to the second side, the at least one aperture having an inner diameter smaller than an outer diameter of an earring coupling member, wherein a material lining the inner diameter of the at least one aperture has a coefficient of friction sufficient to maintain the earring coupling member within the aperture when the support member is positioned with the aperture extending in a substantially vertical orientation.

12. The apparatus of claim 11, wherein the planar support member comprises a first material having a structural rigidity sufficient to maintain the first side and the second side in a substantially planar orientation and wherein the material lining the inner diameter of the at least one aperture comprises a second material.

13. The apparatus of claim 11, wherein the planar support member comprises a material having a coefficient of friction sufficient to maintain the earring coupling member within the aperture when the support member is positioned with the aperture extending in a substantially vertical orientation.

14. The apparatus of claim 11, wherein the support member comprises an elastomer having a coefficient of friction sufficient to maintain the earring coupling member within the aperture when the support member is positioned with the aperture extending in a substantially vertical orientation.

15. The apparatus of claim 11, wherein the at least one aperture comprises at least two apertures, each of the at least two apertures extending through the support member from the first side to the second side, each of the at least two apertures having an inner diameter smaller than the outer diameter of the earring coupling member.

16. The apparatus of claim 11, wherein the at least one aperture comprises a plurality of apertures, each of the plurality of apertures extending through the support member from the first side to the second side, each of the plurality of apertures having an inner diameter smaller than the outer diameter of the earring coupling member.

17. The apparatus of claim 11, wherein the inner diameter of the at least one aperture is substantially smaller than about 0.033 inches.

18. A method for storing an earring, the method comprising:
providing a planar support member comprising a first side, a second side and a peripheral edge, the first side disposed opposite the second side with the peripheral edge separating the first side from the second side, the support member having at least one aperture extending through the support member from the first side to the second side, the at least one aperture having an inner diameter smaller than an outer diameter of an earring coupling member; and
positioning the earring coupling member of an earring through the at least one aperture.

19. The method of claim 18, wherein the at least one aperture comprises a first aperture and a second aperture, wherein the earring coupling member is positioned through the first aperture, wherein the method further comprises positioning a second earring coupling member of a second earring through the second aperture.

20. The method of claim 18, wherein a material lining the inner diameter of the at least one aperture has a coefficient of friction sufficient to maintain the earring coupling member within the aperture when the support member is positioned with the aperture extending in a substantially vertical orientation.
